(19) United States
(12) Patent Application Publication
(10) Pub. No.: US 2023/0125346 A1
(43) Pub. Date: Apr. 27, 2023

(54) Tailoring Thermoelastic Constants of Cellular and Lattice Materials with Pre-Stress for Lightweight Structures

(71) Applicant: PVT Clean Energy LLC, Poughkeepsie, NY (US)

(72) Inventors: Huiming YIN, Alpine, NJ (US); Frank PAO, Boston, MA (US); Mehdi ZADSHIR, New York, NY (US); Junhui LOU, Tenafly, NJ (US); Chao LIU, New York, NY (US)

(21) Appl. No.: 17/935,155

(22) Filed: Sep. 26, 2022

Related U.S. Application Data
(60) Provisional application No. 63/248,502, filed on Sep. 26, 2021.

(51) Int. Cl. E04C 5/12; B29C 70/56

(52) U.S. Cl. CPC E04C 5/12; B29C 70/56; B29L 2001/002

(57) ABSTRACT

Thermoelastic constants of cellular and lattice materials are tailored with pre-stress using four configurations. First, a tube-core composite uses lightweight materials as a core. A screw cap is used to adjust the pressure on the lightweight material core, tailoring the thermoelastic constants of the overall composite. Second, pre-tensioned fibers or metal wires are embedded in the lightweight material during the fabrication and curing process to form a composite. After the lightweight material is solidified, the pre-tension is released from the frame and transferred to the composite. Third, the lightweight material is fabricated in a mold with fiber or wire reinforcements, where the ends extend beyond the lightweight material and are coupled to bolts. Post-tension is applied by adjusting the bolts. Fourth, the ends of the fiber are coupled to a spool. Post-tension is applied to the fibers or wires by turning the spool using a single screw bolt.

### BACKGROUND OF THE INVENTION

With the advancement of nanotechnology, additive manufacturing, and miniaturization, the design and control of material behavior can scale from nanometers to meters. To improve material efficiency, lightweight materials meeting certain stiffness and thermophysical requirements are particularly attractive in building, vehicle, vessel, aircraft, and space applications. Two classes of lightweight materials have been widely used, cellular materials and lattice materials.

Cellular materials are made through a foaming process with open or closed cells having high porosity. Cellular materials are lightweight and provide heat and acoustic insulation, energy and material efficiency, and flexibility in the design and manufacturing of engineering structures. They can be used as a stand-alone material or in form of composites. Since cellular materials have less mass than solid materials, the stiffness and strength of the cellular materials are also less than solid materials. The mechanical response pattern of cellular materials can also be different under different loading conditions. Cellular materials provide flexibility and the potential to design new materials with special mechanical properties. Lattice materials are made of one-dimensional (1D) bars or two-dimensional (2D) plenary members with a certain pattern. Particularly, with 3D printing technology, lattice materials can be easily designed and fabricated.

In conventional pre-stressed concrete, compression is mainly applied in the concrete, which exhibits high compressive strength but low tensile strength. Thus, the concrete overall can sustain a higher tensile load by being pre-stressed. However, because both the reinforcement and concrete are continuum solids, the effective stiffness of the pre-stressed concrete is typically independent of the pre-stress.

### BRIEF SUMMARY OF THE INVENTION

Disclosed herein are pre-tensioned and post-tensioned cellular and lattice materials with tailored thermoelastic constants as specified in the independent claims. Embodiments of the present invention are given in the dependent claims. Embodiments of the present invention can be freely combined with each other if they are not mutually exclusive.

According to a first embodiment of the present invention, a tube-core composite includes a tube with a closed end and an open end, a core composed of a cellular or lattice material, and a screw cap with threads on an outside surface. The open end of the tube includes threads on an inside surface of the tube. The threads on the outside surface of the screw cap are configured to engage the threads on the inside surface of the tube. The core resides within the tube. The screw cap contacts the core and applies pressure to the core. A depth in which the screw cap resides within the tube determines an amount of pressure applied to the core, and the amount of pressure applied to the core determines a stiffness coefficient and a thermal expansion coefficient of the tube-core composite.

In one aspect of the first embodiment, a change in the depth in which the screw cap resides within the tube changes the amount of pressure applied to the core. The amount of change of the pressure applied to the core determines an amount of change in the stiffness coefficient and the thermal expansion coefficient of the tube-core composite.

According to a second embodiment of the present invention, a pre-tension long-fiber reinforced composite includes a cellular or lattice material and a plurality of reinforcements. The plurality of reinforcements includes pre-tensioned fiber or metal wire, where the plurality of reinforcements is embedded in the cellular or lattice material during a fabrication and curing process. After the cellular or lattice material solidifies, pre-tension in the plurality of reinforcements is released and transferred to the cellular or lattice material.

In one aspect of the second embodiment, an amount of a pre-tension load applied to the plurality of reinforcements during the fabrication and curing process determines a stiffness coefficient and a thermal expansion coefficient of the pre-tension long-fiber reinforced composite.

According to a third embodiment of the present invention, a post-tensioned long-fiber reinforced composite includes a cellular or lattice material, a plurality of reinforcements including pre-tensioned fiber or metal wire, and a plurality of bolts. The plurality of reinforcements is embedded in the cellular or lattice material during a fabrication and curing process. The plurality of bolts is coupled to a plurality of ends of the plurality of reinforcements and protrudes beyond an edge of the cellular or lattice material. Each of the plurality of bolts is adjustable after the fabrication and curing process to increase or reduce an amount of protrusion beyond the end of the cellular or lattice material. An adjustment of the amount of protrusion beyond the end of the cellular or lattice material of a given bolt determines an amount of post-tension applied to the reinforcement coupled to the given bolt.

In one aspect of the third embodiment, after the fabrication and curing process, a change in the amount of protrusion beyond the end of the cellular or lattice material for the given bolt changes the amount of post-tension applied to the reinforcement coupled to the given bolt.

According to a fourth embodiment of the present invention, a post-tensioned long-fiber reinforced composite includes a cellular or lattice material, a plurality of reinforcements including pre-tensioned fiber or metal wire, and a spool. The plurality of reinforcements is embedded in the cellular or lattice material during a fabrication and curing process. The spool is coupled to a plurality of ends of the plurality of reinforcements. A single crew bolt is coupled to an end of the spool. The single crew bolt is turned to adjust the rotation of the spool. The spool is adjustable after the fabrication and curing process to increase or reduce an amount of post-tension applied to the reinforcement.

In one aspect of the fourth embodiment, after the fabrication and curing process, a change in the rotation of the spool changes the amount of post-tension applied to the reinforcement coupled to the given spool.

### BRIEF DESCRIPTION OF DRAWINGS

FIG. 1A illustrates a tube-core composite with a core of lightweight material and a screw cap, according to the first embodiment.

FIG. 1B illustrates a cross-sectional view of the tube-core composite.

FIG. 2 illustrates a top orthogonal view of the screw cap.

FIGS. 3A-3B illustrate the application of pre-tension to the tube-core composite.

FIG. 4A illustrates a hexagonal lattice material with the bonds made of springs with the coefficient of K and the length 2l₀.

FIG. 4B shows the Singum particle at the 0th node in FIG. 4A.

FIG. 4C illustrates the variation of Young’s modulus E and Poisson’s ratio v with the variation of λ.

FIG. 5 illustrates pre-tension long-fiber reinforced composites, according to a second embodiment.

FIG. 6A illustrates a post-tensioned long-fiber reinforced composite, according to a third embodiment.

FIG. 6B illustrates a cross-section of the post-tensioned long-fiber reinforced composite.

FIGS. 7A-7B illustrate the adjustment of tension in the post-tensioned long-fiber reinforced composite.

FIG. 8A illustrates a layer of the post-tensioned long-fiber reinforce composite composed of a lightweight material and fiber or wire reinforcements embedded in the lightweight material.

FIG. 8B illustrates a cross-section of the post-tensioned long-fiber reinforced composite along axis A-A shown in FIG. 8A.

FIG. 9A and FIG. 9B illustrate close-up views of a first end and a second end of the spool, respectively.

FIG. 10A illustrates a close-up view of the first end of the spool with the first support grove.

FIG. 10B illustrates a close-up cross-sectional view of the first end of the spool along the B-B axis shown in FIG. 10A.

FIG. 11 illustrates an exploded view of the first end of the spool.

FIGS. 12A-12B illustrate cross-sectional views of the adjustment of the single screw bolt along the B-B axis shown in FIG. 10A.

### DETAILED DESCRIPTION OF THE INVENTION

The following description is presented to enable one of ordinary skill in the art to make and use the present invention and is provided in the context of a patent application and its requirements. Various modifications to the embodiment will be readily apparent to those skilled in the art and the generic principles herein may be applied to other embodiments. Thus, the present invention is not intended to be limited to the embodiment shown but is to be accorded the widest scope consistent with the principles and features described herein.

Reference in this specification to “one embodiment,” “an embodiment,” “an exemplary embodiment,” “some embodiments,” or “a preferred embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments. In general, features described in one embodiment might be suitable for use in other embodiments as would be apparent to those skilled in the art.

In both cellular and lattice materials, the 3D volume of the material is formed by 1D links or 2D panels with periodic or random connections. By manipulating the connections and microstructure, some unique material properties can be obtained, such as negative thermal expansion coefficient and negative Poisson’s ratio. When the cellular or lattice materials are under thermomechanical loading, the induced stresses are transferred in the 3D volume through the forces in those 1D or 2D members. It is challenging to use the continuum mechanics-based method to predict the effective material behavior. In the preparation and characterization of the material, many trial-and-error iterations are often required, as well as versatile skills or experience in designing and predicting material behavior. In general, once a material is designed and fabricated, the mechanical properties, such as the Young’s modulus, the Poisson’s ratio, and the thermal expansion coefficient, will be intrinsic parameters of the material.

Embodiments of the invention use the following mechanisms to tailor the thermoelastic constants of cellular and lattice materials (“lightweight materials”) by pre-stress. First, although the 3D volume of the material exhibits small overall deformation, the individual 1D or 2D members may exhibit large deformations. Second, even when a small external load is applied to the material, a large change in the force and deformation of the 1D or 2D members can be induced due to strong anisotropy. Third, the force changes with the configuration of the microstructure of the material, which significantly changes the effective thermoelastic behavior of the materials. By working with these mechanisms, embodiments of the invention are able to tailor the Young’s modulus, the Poisson’s ratio, and the thermal expansion coefficient, among other elastic constants, through the application of applying pre-stress to the lightweight materials. With the embodiments of the invention, the pre-stress on the cellular or lattice materials with 1D or 2D members will interact with the load with configurational force.

In a first embodiment, a tube-core composite uses lightweight materials as a core filling in a tube with a lubricated inner surface. A screw cap is used to adjust the pressure on the lightweight material core, and in turn, tailors the thermoelastic constants of the overall composite.

In a second embodiment, pre-tensioned fibers or metal wires are embedded in the lightweight material during the fabrication and curing process to form a composite. After the lightweight material is solidified, the pre-tension is released from the frame and transferred to the composite. After a period of time, the lightweight material is placed under compression, and the fibers or wires are subjected to a smaller tension.

In a third embodiment, the lightweight material is fabricated in a mold with fiber or wire reinforcements. The ends of the fiber or wire reinforcements extend beyond the ends of the lightweight material. After the lightweight material is solidified with full strength and stiffness, post-tension is applied to the fibers or wires, placing the lightweight material under compression.

### Tube-Core Composite With a Screw Cap

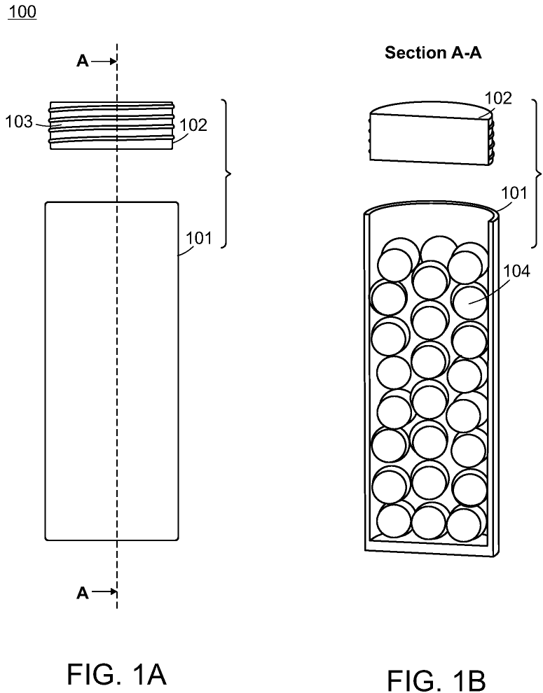

FIG. 1A illustrates a tube-core composite with a core of lightweight material and a screw cap, according to the first embodiment. FIG. 1B illustrates a cross-sectional view of the tube-core composite. The composite 100 includes a thin-walled tube 101, made of a material such as a polymer or metal. The tube 101 has a closed end and an open end. The open end includes threads (not shown) on the inside surface. A screw cap 102 with threads 103 on its outside surface engages threads (not shown) at the open end of the tube 101. FIG. 2 illustrates a top orthogonal view of the screw cap 102. The screw cap 102 includes a drive socket 105 for engaging a turning tool, such as a ratchet or wrench. A core 104 composed of lightweight materials resides within the tube 101. The inner surface of the tube 101 is lubricated for a frictionless interface with the core 104. The core 104 may be a prefabricated cylinder of ultra-lightweight foam, such as lightweight concrete, thermoset foam, aluminum foam, or lattice material fabricated by 3D printing. Alternatively, hollow balls fill the tube 101 and form the core 104. The hollow balls may be composed of either thin-wall airtight balls or foamed materials.

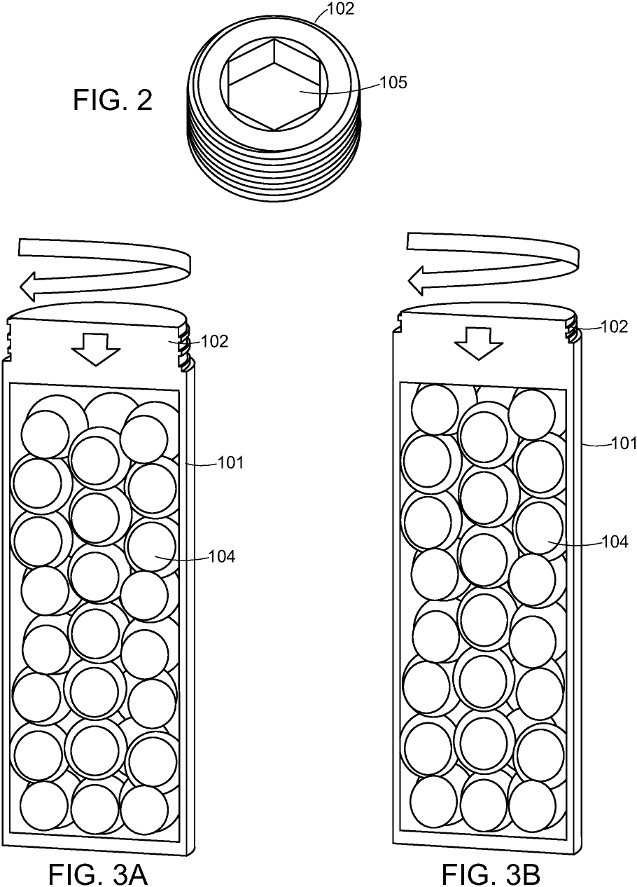

FIGS. 3A-3B illustrate the application of pre-tension to the tube-core composite 100. FIG. 3A illustrates the core 104 prior to the application of pre-tension to the tube 101. Here, the screw cap 102 does not contact the core. FIG. 3B illustrates the application of the pre-tension to the tube 101. The screw cap 102 is turned to adjust the linear motion of the screw cap 102 into the tube 101 until the screw cap 102 contacts the core 104. By adjusting the level of linear motion of the screw cap 102, pressure is applied to the core 104 while the tube 101 is under tensile force. This significantly changes the stiffness and thermal expansion coefficient of the composite 100 by the configurational force during the deformation of the core 104, which can be quantified through the Singum model. A continuum particle model correlates the interatomic potential of a crystal lattice with the elastic moduli of the solid, in which discrete atoms are modeled by perfectly bonded continuum particles, named Singum, to simulate singular forces by stress in continuum. A Singum particle occupies the space of the Wigner Seitz (WS) cell of the atom lattice. The Singum model uses the WS cells of a lattice to represent a continuum solid, so that the singular forces can be transformed into the contacting stress between the continuum particles. By applying a virtual displacement, from the relationship between the virtual stress and strain, the elastic constants are obtained. This procedure can be applied to general lattice networks and foam materials, which exist in nature or metamaterials or composites. Particularly, the additive manufacturing can be used to fabricate lattice materials in a straightforward manner.

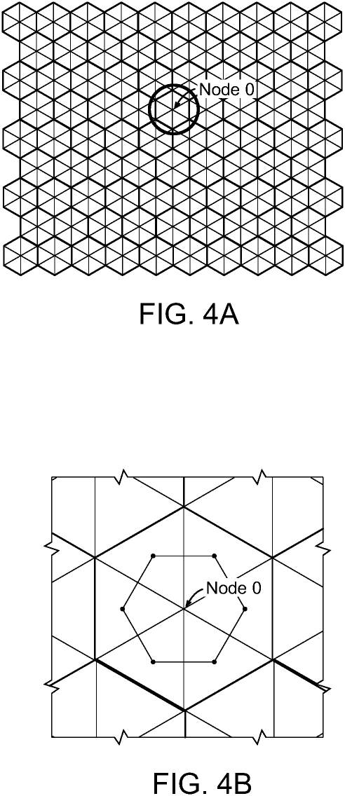

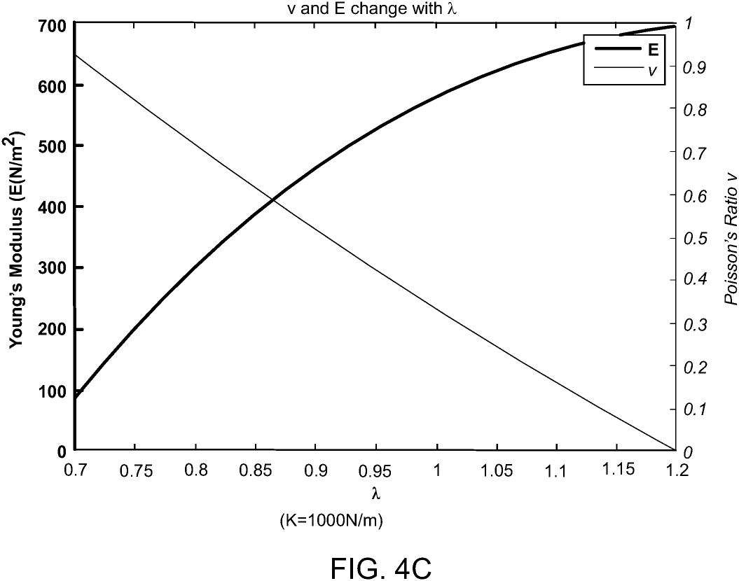

For example, FIG. 4A illustrates a hexagonal lattice material with the bonds made of springs with the coefficient of K and the length 2l₀. The bond length 2l changes with the external load and exhibits a stretch ratio of the spring λ = l/l₀. When λ = 1, the force is zero in the springs. The deformation of the lattice can be represented by the Singum particle through a periodic expansion. FIG. 4B shows the Singum particle at the 0th node in FIG. 4A. When the lattice material is subjected to a uniaxial load, the stress-strain ratio along the load defines the Young’s modulus as

$$E = \frac{\sqrt{3} \left(2 - λ\right) \left(3 λ - 2\right)}{2 + λ} k ,$$

and the transversal strain - axial strain defines the Poisson’s ratio

$$v = \frac{6 - 5 λ}{2 + λ} ,$$

The elastic moduli of E and v change with the prestress or λ. FIG. 4C illustrates the variation of E and v with the variation of λ. When λ = 1, we can obtain E = 0.58 k and v = 0.33. When λ <1, compressive prestress is induced, E increases, v decreases. The pre-stress in a lattice also creates new mechanics and physics of solids as the stress transfer through the lattice is different from the continuum solids. When temperature increases, both the core 104 and tube 101 become more compliant. The pre-stress in the composite 100 will become smaller. Although both the core 104 and tube 101 exhibit thermal expansion to a certain level, the release of the pre-stress will lead to the reduction of the length. Therefore, the effective thermal expansion coefficient can be negative. On the other hand, for airtight balls, the stiffness of the ball will increase with the temperature, so the effective stiffness will increase with the temperature.

At least three unique properties of the tube-core composite 100 can be obtained. First, although the tube-core composite 100 exhibits lightweight with lower the Young’s modulus than the solid counterpart with a zero porosity, the tube-core composite 100 can carry a much higher load in bending than a member with the same weight due to its much higher moment inertia EI. Particularly, this leads to a higher buckling resistance as well because the thin wall that is prone to buckle is under pre-tension. Second, the effective thermal expansion coefficient and elasticity of the lightweight tube-core composite 100 can be tailored by the pre-stress over a large range. A negative thermal expansion coefficient can be obtained. Third, when a large pre-stress is applied, the microstructure of the lightweight material in the core 104 can be significantly changed. The local buckling of the 1D or 2D members can be obtained, so that the effective elasticity can be significantly changed, and negative Poisson’s ratio can be obtained.

### Pre-Tension Long-Fiber Reinforced Composites

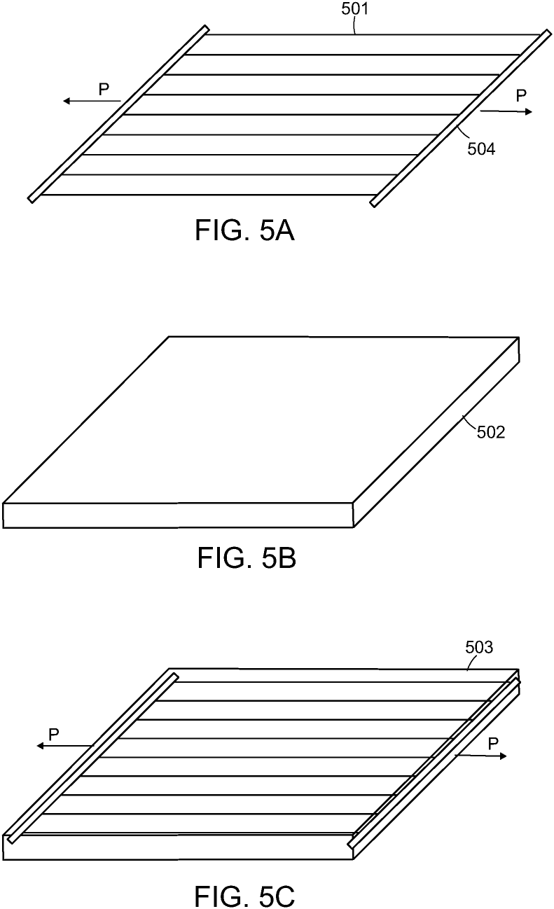

FIG. 5 illustrates pre-tension long-fiber reinforced composites, according to a second embodiment. Pre-tensioned long fiber or metal wire reinforcements 501 are fixed on a frame 504. The reinforcements 501 are embedded in a lightweight material 502 during the fabrication and curing process, forming a composite 503. After the composite 503 is solidified with the full stiffness and strength, the pre-tension is released from the frame 504 and transferred to the composite 503. After a period of time, the lightweight material 502 in the composite will be under compression, and the reinforcements 501 are subjected to a smaller tension. Although FIG. 5 shows one layer of reinforcements 501 in one direction, multiple layers of reinforcements 501 can be used for applying pre-stresses in three orthogonal directions. The composite 503 can be a bar, plate, or block. The stiffness of the composite 503 can be enhanced by the pre-stresses, and anisotropic effective stiffness can be obtained for highly efficient material designs and applications.

At least three unique properties of the pre-tensioned composite 503 can be obtained. First, the stiffness of the composite 503 can be tailored with the pre-tension in a certain direction for higher material efficiency. Different pre-tension loads can be applied, which include numerical value and direction, which leads to different stiffness and thermal expansion coefficients. Second, the effective thermal expansion coefficient can be tailored for near-zero thermal expansion coefficient with the pre-tension. Third, the strength of the composite 503 can be significantly higher than the lightweight material 502 due to the prestress and material reinforcement.

### Post-tensioned Long-Fiber Reinforced Composite

With the pre-tensioned long-fiber reinforced composite 503 described above, once the composite 503 is fabricated, the pre-stress will be fixed. The stiffness and effective thermal expansion coefficient will no longer be adjustable. Moreover, if stress relaxation exists, the pre-stress may be reduced, and the unique material properties caused by the pre-tension will also be reduced over time. To actively tailor the thermoelastic behavior, post-tensioned long-fiber reinforced composites can be used.

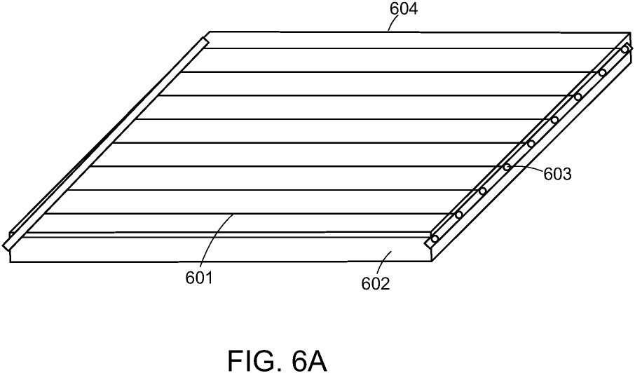

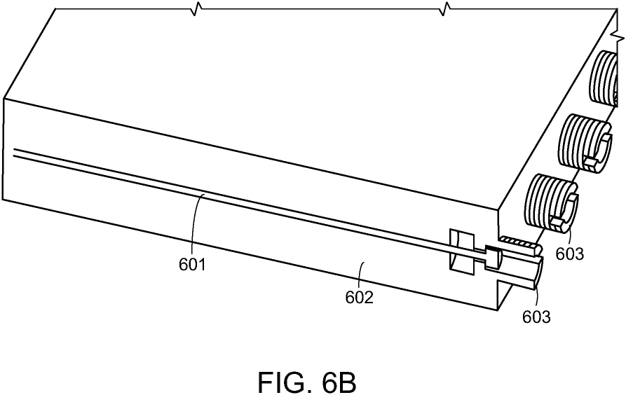

FIG. 6A illustrates a post-tensioned long-fiber reinforced composite, according to a third embodiment. FIG. 6B illustrates a cross-section of the post-tensioned long-fiber reinforced composite. As with the fabrication of the composite 503, fiber or metal wire reinforcements 601 are fixed on a frame. In addition, each fiber or wire reinforcement 601 is coupled to a screw bolt 603 at one end. The reinforcements 601 are embedded in a lightweight material 602 during the fabrication and curing process, forming a composite 604. The screw bolts 603 protrude beyond the lightweight material 602 such that the screw bolts 603 may be turned and adjusted. After the lightweight material 602 is cast in a mold with the reinforcements 601 and solidified with full strength and stiffness, post-tension is applied to the reinforcements 601 through adjustments of the screw bolts 603, such that the lightweight material 602 is under compression. By adjusting the screw bolts 603, the post-tension can be adjusted to tailor the effective stiffness and thermal expansion coefficient. Although FIGS. 6A-6B only shows one layer of reinforcements 601 in one direction, multiple layers of reinforcements 601 can be used for applying post-stresses along the three orthogonal directions. The post-stress in the composite 604 can be changed at any time by adjusting the screw bolts 603.

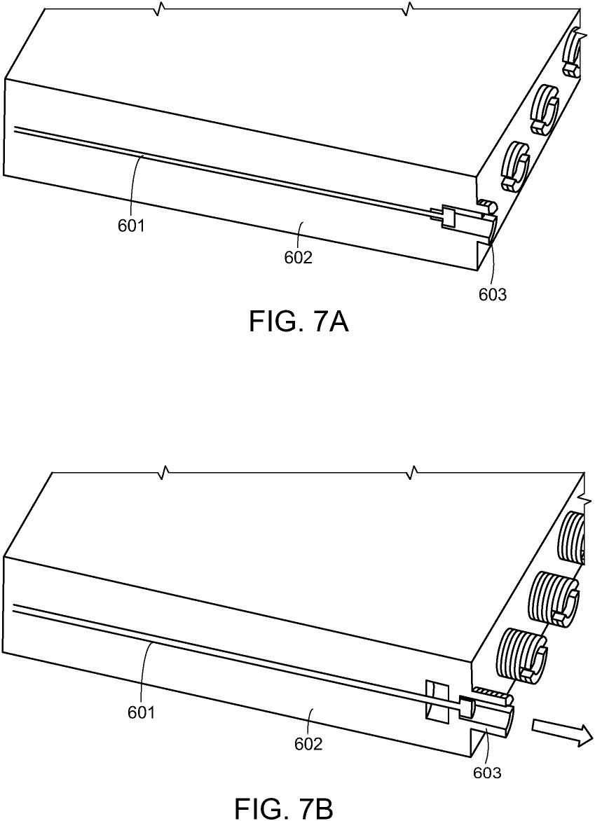

FIGS. 7A-7B illustrate the adjustment of tension in the post-tensioned long-fiber reinforced composite 604. In FIG. 7A, the screw bolt 603 is adjusted to reduce its protrusion beyond the lightweight material 602. This in turn reduces the amount of the post-tension on the fiber or wire reinforcement 601 connected to the bolt 603. In FIG. 7B, the screw bolt 603 is adjusted to increase its protrusion beyond the lightweight material 602. This in turn increases the amount of post-tension on the fiber or wire reinforcement 601 connected to the bolt 603. Different post-tension loads can be applied, which include a value and a direction, which leads to different stiffness and thermal expansion coefficients.

At least three unique properties of the post-tensioned composite 604 can be obtained. First, the stiffness of the composite 604 can be tailored with the post-tension in a certain direction for higher material efficiency. Second, the effective thermal expansion coefficient can be tailored by the pre-tension in a certain range. Third, the strength of the composite 604 can be significantly higher than the lightweight material 602 due to the prestress and material reinforcement.

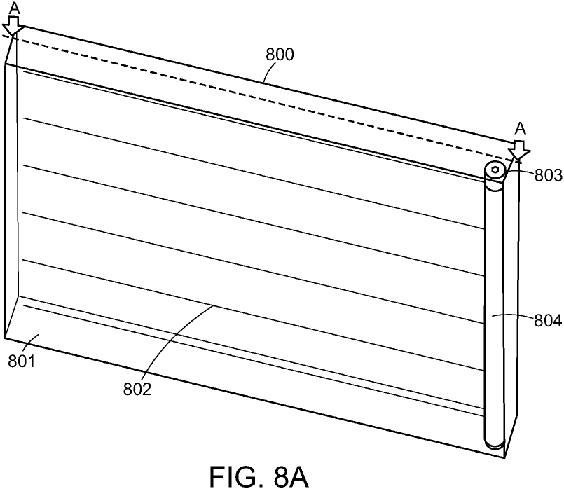

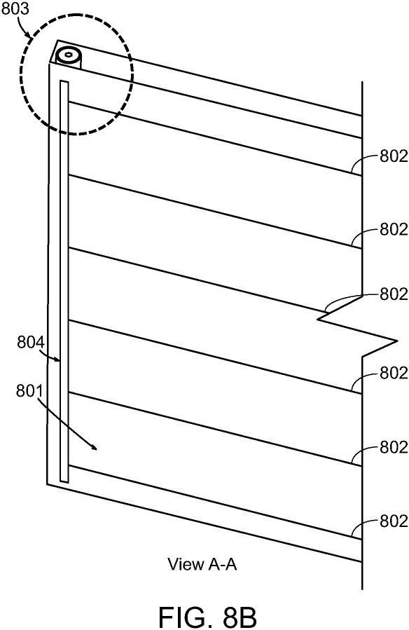

FIGS. 8A-8B illustrate an alternative embodiment of a post-tensioned long-fiber reinforce composite. As illustrated in FIG. 8A, a layer of the post-tensioned long-fiber reinforced composite 800 is composed of a lightweight material 801 with fiber or wire reinforcements 802 embedded in the lightweight material 801. A single screw bolt 803 is coupled to a spool 804. The spool 804 is coupled to the ends of the reinforcements 802, such that adjustments to the screw bolt 803 adjust the tension on all of the reinforcements 802 coupled to the spool 804. FIG. 8B illustrates a cross-section of the post-tensioned long-fiber reinforced composite along axis A-A shown in FIG. 8A. By turning the screw bolt 803, the length of the reinforcements 802 coupled to the spool 804 will change, in turn, changing the post-tension applied to the reinforcements 802.

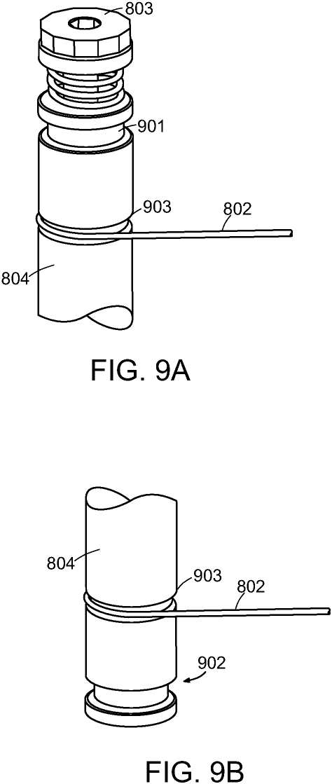

FIG. 9A and FIG. 9B illustrate close-up views of a first end and a second end of the spool 804, respectively. The spool 804 includes a plurality of fiber grooves 903 within which the ends of the reinforcements 802 engage the spool 804. As illustrated in FIG. 9A, the screw bolt 803 is coupled to the first end of the spool 804. The spool 804 includes a first support groove 901. As illustrated in FIG. 9B, a second support groove 902 resides at the second end of the spool 804. The first and second support grooves 901-902 are described further below.

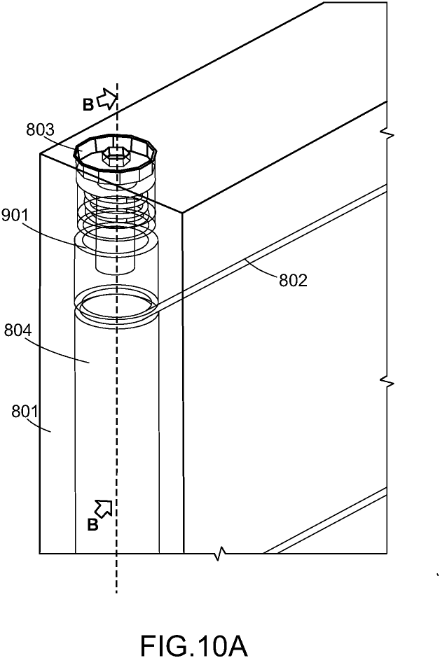

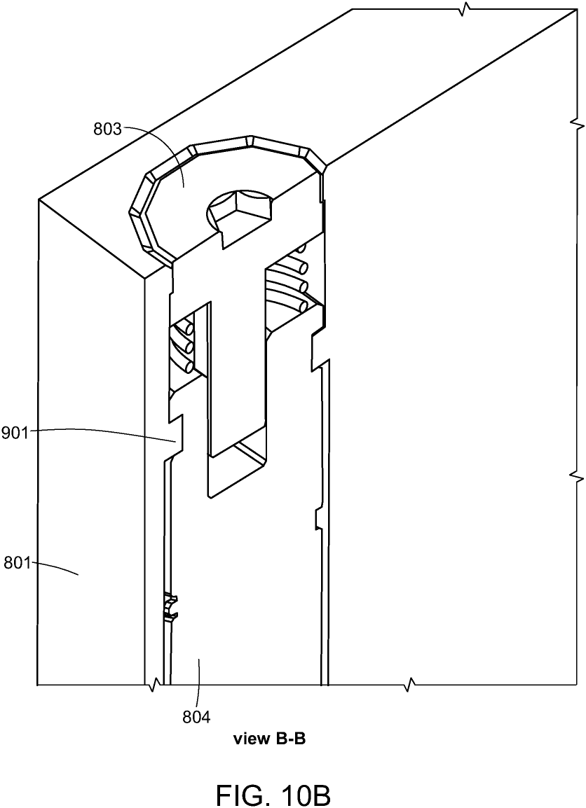

FIG. 10A illustrates a close-up view of the first end of the spool 804 with the first support grove 901. FIG. 10B illustrates a close-up cross-sectional view of the first end of the spool 804 along the B-B axis shown in FIG. 10A. As illustrated in FIGS. 10A and 10B, a contact area exists at the first end of the spool 804 between the lightweight material 801 and the first support grove 901. A similar contact area exists at the second end of the spool 804 between the lightweight material 801 and the second support grove 902(not shown). The contact areas at the first and second ends of the spool 804 allow the spool 804 to rotate along its longitudinal axis while eliminating the other degrees of freedom.

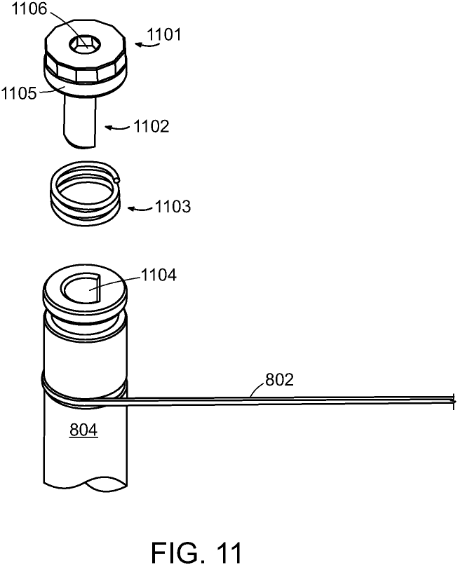

FIG. 11 illustrates an exploded view of the first end of the spool 804. The screw bolt 803 includes an adjustment screw 1101 configured with a polygon-shaped edge, a bearing flange 1105 configured with a round-shaped edge and coupled to the adjustment screw 1101, a guide rod 1102 configured with a “D” shaped cross-section and couple to the bearing flange 1105, and a spring 1103. The adjustment screw 1101 is configured with a hexagonal hole 1106 for engaging a turning tool. The first end of the spool 804 is configured with a guide slot 1104. The screw bolt 803 is coupled to the spool 804 by abutting the spring 1103 against the first end of the spool 804 and placing the guide rod 1102 through the spring and into the guide slot 1104.

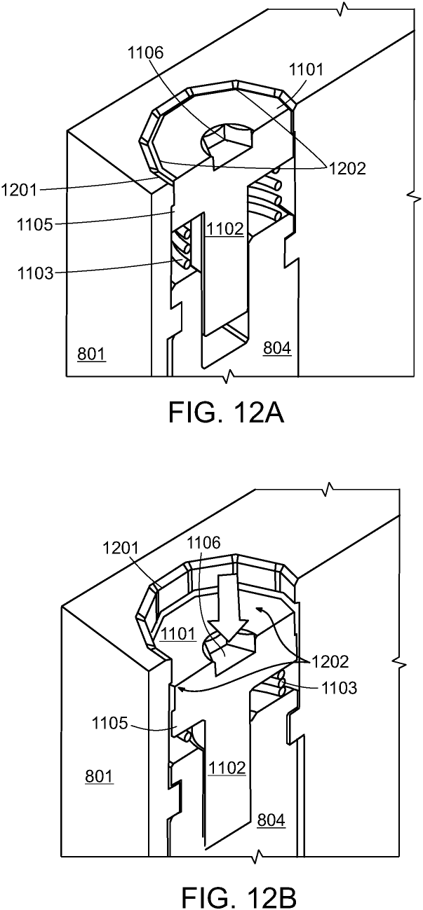

FIGS. 12A-12B illustrate cross-sectional views of the adjustment of the single screw bolt 803 along the B-B axis shown in FIG. 10A. The screw bolt 803 and spool 804 reside within an opening in the lightweight material 801. An end of the opening 1201 is configured with a polygon-shaped edge. The remaining portion of the opening 1201 is configured with a round shape. FIG. 12A illustrates the screw bolt 803 in a locked position. In the locked position, the adjustment screw 1101 resides within the edge of the opening 1201, such that the polygon-shaped edge 1202 of the adjustment screw 1101 engages the polygon-shaped edge of the opening 1201. The adjustment screw 1101 is kept in the locked position by the force of the spring 1103. This prevents the rotation of the adjustment screw 1101, which in turn prevents the rotation of the spool 804.

FIG. 12B illustrates the screw bolt 803 in an unlocked position. By applying a downward push movement to the adjustable screw 1101, the adjustable screw 1101 moves down into the opening 1201, compressing the spring 1103. The spring 1103 is compressed until the polygon-shaped edge 1202 of the adjustment screw 1101 reaches the round edge of the opening 1201 and disengages from the polygon-shaped edge of the opening 1201. This allows the adjustment screw 1101 to rotate, which in turn rotates the spool 804. Upon the rotation of the spool 804, the post tensions on the reinforcements 802 are adjusted using the single screw bolt 803. Since each of the reinforcements 802 is coupled to the spool 804, the post tension on each reinforcement 802 will be approximately the same, which simplifies the adjustment of the post tension for the layer of lightweight material 801.

It should be understood that the exemplary embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from their spirit and scope.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A tube-core composite, comprising:
a tube with a closed end and an open end, the open end comprising threads on an inside surface of the tube;
a core composed of a cellular or lattice material, wherein the core resides within the tube; and
a screw cap comprising threads on an outside surface configured to engage the threads on the inside surface of the tube,
wherein the screw cap contacts the core and applies pressure to the core,
wherein a depth in which the screw cap resides within the tube determines an amount of pressure applied to the core,
wherein the amount of pressure applied to the core determines a stiffness coefficient and a thermal expansion coefficient of the tube-core composite.

2. The tube-core composite of claim 1, wherein a change in the depth in which the screw cap resides within the tube changes the amount of pressure applied to the core, wherein the amount of change of the pressure applied to the core determines an amount of change in the stiffness coefficient and the thermal expansion coefficient of the tube-core composite.

3. The tube-core composite of claim 2, wherein the thermal expansion coefficient is negative or zero.

4. The tube-core composite of claim 1, wherein the core comprises a plurality of hollow balls or foamed lightweight balls.

5. A pre-tension long-fiber reinforced composite, comprising:
a cellular or lattice material; and
a plurality of reinforcements comprising pre-tensioned fiber or metal wire, wherein the plurality of reinforcements is embedded in the cellular or lattice material during a fabrication and curing process,
wherein after the cellular or lattice material solidifies, pre-tension in the plurality of reinforcements is released and transferred to the cellular or lattice material.

6. The pre-tension long-fiber reinforced composite of claim 5, wherein an amount of a pre-tension load applied to the plurality of reinforcements during the fabrication and curing process determines a stiffness coefficient and a thermal expansion coefficient of the pre-tension long-fiber reinforced composite.

7. The pre-tension long-fiber reinforced composite of claim 5, wherein the plurality of reinforcements is embedded in one or more directions.

8. A post-tensioned long-fiber reinforced composite, comprising:
a cellular or lattice material;
a plurality of reinforcements comprising pre-tensioned fiber or metal wire, wherein the plurality of reinforcements is embedded in the cellular or lattice material during a fabrication and curing process; and
one or more bolts coupled to a plurality of ends of the plurality of reinforcements, wherein the plurality of bolts protrude beyond an edge of the cellular or lattice material,
wherein each of the one or more bolts are adjustable after the fabrication and curing process to increase or reduce an amount of protrusion beyond the end of the cellular or lattice material,
wherein, after the fabrication and curing process, an adjustment of the amount of protrusion beyond the end of the cellular or lattice material of a given bolt determines an amount of post-tension applied to the reinforcement coupled to the given bolt.

9. The post-tensioned long-fiber reinforced composite of claim 8, wherein, after the fabrication and curing process, a change in the amount of protrusion beyond the end of the cellular or lattice material for the given bolt changes the amount of post-tension applied to the reinforcement coupled to the given bolt.

10. The post-tensioned long-fiber reinforced composite of claim 8, wherein the plurality of reinforcements is embedded in one or more directions.

11. The post-tensioned long-fiber reinforced composite of claim 8, further comprising:
a spool coupled to the cellular or lattice material and to the plurality of ends of the plurality of reinforcements; and
a single crew bolt coupled to an end of the spool,
wherein adjustments to the single screw bolt turn the spool and adjust the amount of the post-tension applied to the plurality of reinforcements.
